(19) United States
(12) Patent Application Publication
(10) Pub. No.: US 2014/0263218 A1
(43) Pub. Date: Sep. 18, 2014

(54) Method and apparatus for producing a modified edge on a workpiece using a laser beam

(71) Applicant: Preco, Inc., (US)

(72) Inventor: Daniel Miller, New Richmond, WI (US)

(21) Appl. No.: 13/826,625

(22) Filed: Mar. 14, 2013

(51) Int. Cl. B23K 26/38

(52) U.S. Cl. CPC B23K 26/38
USPC 219/121.72; 219/121.67

(57) ABSTRACT

An apparatus and a method using a laser beam to produce a substantially vertical edge on a workpiece using a laser beam. The apparatus comprises a galvanometer for directing the laser beam and at least one substantially straight minor disposed in a substantially vertical position. The substantially straight mirror being positioned to redirect the laser beam on the workpiece at a selected incline, the incline being sufficient to produce the substantially vertical edge.

### FIELD OF THE INVENTION

The present disclosure relates to laser systems for processing material utilizing a laser beam and, in particular, it relates to the use of a laser beam to produce a substantially vertical edge on a workpiece.

### BACKGROUND OF THE INVENTION

Galvanometers are well known devices used in conjunction with lasers covering a spectrum of applications, ranging from entertainment to industrial. They are recognized for their speed and in more recent years also for their precision. While the speed of the galvanometer makes it a logical choice for many laser processing systems other less desirable aspects may make it prohibitive. The angle of incidence is one such shortcoming as it can create an undesired angle of incidence upon a material.

The lineal speed of the galvanometer is accomplished via scanning mirrors. Galvanometer systems for directing laser beams are well known. See U.S. Pat. No. 6,351,324 or U.S. Pat. No. 6,849,823. When used herein, the term “galvanometer” includes the mirrors for directing the laser beam. Relatively small angular movements of a mirror attached to the galvanometer translate into relatively large lineal movement and therefore high speeds of the laser beam along a targeted material. Unfortunately, this action causes the angle of the incident light upon a material to be non-vertical in the field of view (FOV). The FOV is an area, generally very close to square, in which a steered laser beam can process a workpiece. The angle also varies about the FOV of the galvanometer. In a typical 3-axis galvanometer system this range is approximately +/−20 degrees from the center of the FOV to the edge of the FOV. Some 2-axis galvanometer systems overcome this to some extent with the introduction of multi-element flat field lenses. These lens arrangements are placed after the galvanometer and are referred to as a pre-scanning objective arrangement.

For applications requiring a vertical edge, even with the beam in a vertical orientation or through the center of the FOV, a tapered/beveled cut edge is still produced. This taper is more pronounced when cutting along the edge of the FOV and is progressively less when coming towards the center but can still be present. The focused laser beam occupies a certain area and in general has a Gaussian profile or bell shape. This, in conjunction with the thermal nature of, for example, a C02 laser beam, creates a tapered edge even with a vertically presented laser beam. This can be exaggerated in what is referred to as kiss cutting applications, where the laser beam is presented in a manner to just cut through a layer and/or layers of material without cutting excessively far into another layer or the work support.

In these applications variations to the method of processing can be utilized to overcome this and also take advantage of the angular presentation of the beam to the material by placing the material/part near one side of the FOV at the desired angle. This method reduces the useable FOV from a given location of the galvanometer as the desired angle occurs in one location for a particular side of a material/part. If the material/part is intended to be processed from multiple sides, this requires either the galvanometer and/or the material/part to be repositioned such that the desired angle can be achieved in various locations about the material/part.

This additional repositioning action detracts from the potential throughput speed the laser system would be capable of with a more conventional method (where the material/part is processed from one location for the most part centered about the FOV for parts that fit within the FOV). One approach to regain the throughput would be to incorporate multiple galvanometers (and possibly lasers) to present the beam at the appropriate angle for each side of a four sided part. This increases the system complexity and can be cost prohibitive.

### SUMMARY OF THE INVENTION

The present invention includes an apparatus for producing a substantially vertical edge on a workpiece using a laser beam. The apparatus comprises a galvanometer for directing the laser beam and at least one substantially straight mirror disposed in a substantially vertical position. The substantially straight mirror being positioned to redirect the laser beam on the workpiece at a selected incline, the incline being sufficient to produce the substantially vertical edge.

The present invention also includes a method for producing a substantially vertical edge on a workpiece using a laser beam, the method comprises using a galvanometer operated mirror system to direct a laser beam to a substantially straight mirror. The substantially straight mirror being positioned substantially normal to the workpiece and above the workpiece and redirecting the laser beam to the workpiece using the substantially straight mirror at an angle of incidence such that a distal end of the laser beam produces a substantially vertical edge portion in the workpiece.

### DESCRIPTION OF THE DRAWINGS

FIG. 1 is a perspective view of an apparatus illustrating the method of this invention.

FIG. 2 is a plan view of the steered laser beam of this disclosure.

FIG. 3 is an enlarged view of the dashed circle 3 in FIG. 2.

FIG. 4 is an enlarged view of the distal end of a focal point of a laser beam.

FIG. 5 illustrates a prior art laser beam cutting a work piece.

### DETAILED DESCRIPTION OF THE INVENTION

This disclosure describes a more cost effective method and apparatus to overcome the shortcomings of the prior art systems in producing a substantially vertical edge. What is meant by “vertical edge” is an edge whose edge surface is aligned in a plane that is substantially normal to the adjoining top surface of the part being produced. For simplicity a method and apparatus is described herein for converting a 4 sided part from a flat sheet of material containing one and/or multiple layers/zones of material at a desired angle of incidence to the material. It should be understood that the apparatus described is not intended to be limited in its use to a four (4) sided part or for that matter, a “cutting” application. The apparatus described herein can also be used to make other polygon shapes.

The apparatus utilizes a multi-axis galvanometer in conjunction with one (1) or more mirrors and/or mirror sets (4 mirrors for a four-sided part). A typical configuration of the invention of this disclosure is illustrated in FIG. 1. FIG. 1 illustrates a simplified schematic using the apparatus 100 of this disclosure. A galvanometer 110 having a large enough FOV is chosen and a plurality of substantially vertically placed mirrors 112, 114, 116, and 118 are disclosed on or near a working surface of a work piece 124. The number of mirrors used will vary depending on the number of straight line cuts to be made in the work piece. A laser beam from a laser source (not shown) is directed towards the galvanometer. The galvanometer directs a steered beam portion 120 of the laser beam, which is intercepted by one of the mirrors 112, 114, 116, or 118. The beam is then redirected as illustrated by redirected beam portion 122 onto the work piece 124. The mirrors 112, 114, 116 and 118 are substantially straight in their longitudinal direction and flat. The laser beam directed by these minor on to the workpiece therefore produces a straight line.

A plan view of the galvanometer 110, the steered beam portion 120, the intersecting mirrors and the redirected beam 122 is illustrated in FIG. 2. The mirrors 112, 114, 116 and 118 are positioned below the galvanometer within the FOV to intercept the beam 120 and redirect the beam 122 back towards the center of the FOV at a selected angle. If the mirrors are placed substantially vertically with respect to the work piece 124, the beam is inverted and the focal plane is maintained. The angle of the mirrors can be fixed and/or adjusted, either manually or via a controller. The purpose of adjusting the angle of the mirrors with respect to the horizontal will be explained further below. In addition, the location of the mirrors can also be fixed or adjustable, either manually or via controller, to accommodate various part sizes positioned within the FOV. The number of mirrors used generally reflects the number of straight line cuts to be made in the work piece 124. For example, if the part to be cut is triangular in shape, then only three minors need be used. For a rectangular part, four mirrors, for a pentagon shaped part, 5 mirrors and so on. In view of this discussion the configuration illustrated in FIG. 1 can be modified as discussed above and be within the scope of this disclosure.

An enlarged portion of the dashed line area 3 of FIG. 2 is illustrated in FIG. 3. The mirrors 112, 114, 116 and 118 are primarily used to redirect the laser beam as illustrated by 122 so that a vertical edge is produced in the work piece 124 to produce part 126. An enlarged portion of the distal end of the laser beam proximate its focal point is illustrated in FIG. 4 as indicated by reference character 130. The focal point and area associated with the focal point 132 is characterized by a Gaussian or bell curve shape. As illustrated in FIG. 5, when a laser beam 150 is directed vertically to a workpiece, the configuration of the distal end 154 of the laser beam then produces a cut edge on the work piece that is not vertically oriented. The sides of the cut will be beveled to complement the shape of the distal end of the beam.

In many applications it is particularly important that such edges be a vertical cut edge. A vertically directed laser beam 200 will not produce such a substantially vertically cut edge as illustrated in FIG. 5. The vertically directed beam 200 produces a beveled edge 202 in the workpiece 204. This disclosure describes a method of redirecting or steering a laser beam to produce such a vertical edge by placing the distal portion of the laser beam at an angle of incidence such that a vertically cut edge is produced on the part 126. Of course, a very non-vertical edge is produced on the complimentary cut edge 134 but this is not of concern since edge 134 is the edge for scrap piece 136.

With appropriate processing speed, laser power, and number of passes, a desired cut angle (typically vertical but not limited to) can be achieved at a process rate typically expected from a galvanometer based laser processing system. Following is a more specific example of the apparatus and method of this disclosure.

### Comparative Example

The method and apparatus described herein was used to produce products from an optical film, whereby the side edges were laser cut with minimum tapering (edge perpendicular to the planar surface of the part) by the use of one laser/galvanometer with no additional translational motion of either the part or the galvanometer. The result was the cutting time was only slightly slower than the normal cutting method with a standard galvanometer under the same processing steps. For example, a part was produced using seven (7) multiple passes on each side which resulted in a cutting time of about 1.9 seconds per part, producing a substantially vertical edge. When utilizing a standard galvanometer system (one that produced an undesirable beveled edge) seven (7) multi-passes resulted in a cutting time of 1.7 seconds. The 1.9 or the 1.7 cycle time is approximately three times faster than the cycle time that can be realized with a conventional galvanometer based system (such as a standard Preco FlexPro) that requires either the material or the galvanometer system to be repositioned an additional 3 times to produce a vertical edge on all four sides of a given part. The apparatus and method of this disclosure also allows adoption directly to a wide web system where part production per second will be proportionally increased by the number of laser/galvo combinations.

A primary feature of this disclosure is the cutting angle of the laser beam with respect to the cutting edge of the sample. In order to minimize the tapering (beveled edge) on the cut edge such that a cut edge essentially vertical to the planar surface is produced, the laser beam from the galvanometer must be entered from the outside of the cut edge at an inclined angle, nominally at 20 degrees from the normal horizontal. This means the part is always cut at all sides at the edge of the field from a galvanometer that is located outside the central position of the part. This is contrary to normal galvanometer cutting where the part is positioned at the center of the field of view. Therefore, to achieve vertical cut edge, either the part or the galvanometer were physically moved in prior systems so that the desired cut line is at the edge of the field of view. These extra motions of prior art systems for presenting the part at the right cutting angle are the primary reasons for the increase in the cutting cycle time for the part.

This disclosure also describes a multiple pass cutting technique that is utilized in order to keep the product clean as well as produce consistent edge quality. Depending on the thickness of the film, different number of multi-cut passes may be used to maintain a vertical cut edge. Experimental results show that the latitude for achieving vertical cut edges increases with multiple passes. Furthermore, in order to utilize a thinner polypropylene liner (approximately 2 mil) in some applications, at least one kiss cut is necessary to avoid cutting through the liner. Multiple passes have also shown to be advantageous for the retention of the uncoated liner to the cut part. For example, in using nonadhesive-coated PET (polyethylene terephthalate) liner, lamination integrity has substantially increased with multiple cuts at an inclined angle. Similarly, multiple cuts on the bottom liner would also show to avoid traps of unintended air or debris. As many as seven (7) passes have been used to achieve high quality results. While multiple passes contribute to the increase in cutting time, the translational motions required to present the part adequately to the inclined cut angle are the major factors that increase cut time in prior art systems. Therefore, it is the purpose of this disclosure to provide a practical configuration for the optical system so a single galvanometer is used. An alternative is the use of four galvanometer systems, which is expensive.

Although the present invention has been described with reference to preferred embodiments, workers skilled in the art will recognize that changes may be made in form and detail without departing from the spirit and scope of the invention.

What is claimed is:

1. An apparatus for producing a substantially vertical edge on a workpiece using a laser beam, the apparatus comprising:
A galvanometer for directing the laser beam; and
At least one substantially straight mirror disposed in a substantially vertical position, being positioned to redirect the laser beam on the workpiece at a selected incline, the incline being sufficient to produce the substantially vertical edge.

2. The apparatus of claim 1 and further comprising a plurality of substantially straight mirrors each disposed in the substantially vertical position, the substantially straight mirrors being arranged to define a polygon shaped part to be cut from the workpiece, each of the substantially straight mirrors also positioned to redirect the laser beam received from the galvanometer onto the workpiece to produce the part.

3. The apparatus of claim 1 wherein the galvanometer is a single galvanometer and further comprising a plurality of substantially straight mirrors each disposed in a substantially vertical position, the substantially straight mirrors arranged to define a polygon shape, and each of the substantially straight mirrors positioned to receive and redirect the laser onto the workpiece to produce a part having a substantially vertical edge along the part's polygon perimeter.

4. The apparatus of claim 1 wherein the at least one substantially straight mirror is adjustable angularly with respect to the workpiece.

5. The apparatus of claim 1 wherein the galvanometer has a field of view and the at least one substantially straight mirror is positionable within the field of view.

6. A method for producing a substantially vertical edge on the workpiece using a laser beam, the method comprising:
Using a galvanometer operated mirror system to direct a laser beam on to a substantially straight minor, the substantially straight mirror being positioned substantially normal to the workpiece and above the workpiece; and
Redirecting the laser beam to the workpiece using the substantially straight mirror at an angle of incidence such that a distal end of the laser beam produces a substantially vertical edge portion in the workpiece.

7. The method of claim 6 wherein the laser beam is directed through a single galvanometer system and directed to a plurality of substantially straight mirrors each mirror being substantially normal to the workpiece, the substantially straight minors arranged to define a polygon shape; the laser beam being directed to be reflected by each of the substantially straight minors towards the workpiece angle of incidence that produces a substantially vertical edge portion in the workpiece reflecting the polygon shape.

8. The method of claim 6 wherein the laser beam is directed along the substantially straight mirror a plurality of times, each time the focal point of the laser beam processing the edge of the workpiece horizontally in vertically adjacent lines of processing to produce a vertical edge.

9. The method of claim 6 wherein the at least one substantially straight minor is adjustable angularly with respect to the workpiece.

10. The method of claim 6 wherein the galvanometer operated minor system has a selected field of view for operation and the at least one substantially straight mirror is positioned within the field of view.
